(19) United States
(12) Patent Application Publication
(10) Pub. No.: US 2026/0181552 A1
(43) Pub. Date: Jun. 25, 2026

(54) HARMONIZED DESIGN FOR A LOW-POWER WAKE-UP SIGNAL

(71) Applicant: Apple Inc., Cupertino, CA (US)

(72) Inventors: Sigen Ye, Whitehouse Station, NJ (US); Chunxuan Ye, San Diego, CA (US); Dawei Zhang, Saratoga, CA (US); Hong He, San Jose, CA (US); Huaning Niu, San Jose, CA (US); Wei Zeng, Saratoga, CA (US); Weidong Yang, San Diego, CA (US)

(21) Appl. No.: 18/848,039

(22) PCT Filed: Aug. 7, 2024
(86) PCT No.: PCT/US2024/041339

§ 371 Date: Sep. 17, 2024

Related U.S. Application Data
(60) Provisional application No. 63/531,964, filed on Aug. 10, 2023.

(51) Int. Cl. H04W 52/02; H04L 27/00

(52) U.S. Cl. CPC H04W 52/0235; H04L 27/0008

(57) ABSTRACT

Disclosed are methods, systems, and computer-readable medium to perform operations including generating a low-power wake-up signal (LP WUS) having a first portion of information bits carried by one or more orthogonal frequency-division multiplexing (OFDM) symbols via modulation based on multi-carrier on/off keying (MC-OOK) and a second portion of information bits carried by a bit-to sequence mapping on the one or more OFDM symbols; and transmitting, to a set of one or more user equipment devices (UEs), the generated LP WUS.

### CLAIM OF PRIORITY

This application claims priority under 35 U.S.C. § 119 (e) to U.S. Patent Application Ser. No. 63/531,964, filed on Aug. 10, 2023, the entire contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

A user equipment (UE) can operate in an idle mode when not needed to conserve power. When the UE is needed by the network, the network (e.g., through a base station) can send a wake-up signal (WUS) to the UE. The UE periodically monitors for the WUS. For example, the UE will wake-up at the subframe where the UE expects a paging operation (PO) and reads the paging messages. The paging messages include a temporary mobile subscriber identity (TMSI) value for the UE. If the UE does not find the TMSI of the UE inside the paging messages, the UE assumes that it is not paged, and it will go back to idle mode. However, if the UE finds the TMSI for the UE in one of the paging messages, the UE determines that the page is addressed to it, and it will initiate a radio resource control connection.

### SUMMARY

A harmonized design for low-power wake-up signals is described herein for Fifth Generation (5G) telecommunications networks. A wake-up signal (WUS) is configured to accommodate user equipment (UE) having one of multiple wake up receiver types. A wake-up receiver may include an on/off keying (OOK)-based receiver and a sequence-based receiver. The wake-up signal can be a multi-carrier OOK-based waveform generated by modulating one or more subcarriers with sequence(s) that are known to the UE. The WUS may include a hybrid design to carry a low-power (LP) WUS payload that can accommodate a mix of the OOK-based receiver and sequence-based receiver at the UEs. The wake-up signal payload may be split into two parts. A first part may be carried via multi-carrier on/off keying (MC-OOK) modulation. The second part may be carried via a bit-to-sequence mapping on the time segment(s) or frequency segment(s) of the MC-OOK orthogonal frequency-division multiplexing (OFDM) symbol(s).

The harmonized design, including the first and second parts of the WUS payload, is configured to satisfy the following objectives in relation to a low-power wake-up signal and a low-power wake-up receiver (LP WUS/LP WUR) for new radio (NR) networks. The WUS/WUR configurations described herein can be used by low-power WUS/WUR for power-sensitive, small form-factor devices including internet of things (IoT) devices. The devices that use the LP WUS/WUR described herein can include industrial sensors and controllers, small devices such as wearables, and so forth. Layer 1 (L1) procedures and higher layer protocols that support the wake-up signals are described herein.

The harmonized design for the LP WUS/WUR described herein enables power saving mechanism, improved coverage availability, and minimizing a latency impact for UEs. The LP WUS/WUR can also reduce overhead for system impact, such as network power consumption, coexistence with non-low-power-WUR UEs, network coverage/capacity/resource overhead, and so forth.

In a general aspect, a process includes generating a low-power wake-up signal (LP WUS) having a first portion of information bits carried by one or more orthogonal frequency-division multiplexing (OFDM) symbols via modulation based on multi-carrier on/off keying (MC-OOK) and a second portion of information bits carried by a bit-to sequence mapping on the one or more OFDM symbols; and transmitting to a set of one or more user equipment devices (UEs) the generated LP WUS.

In some implementations, the bit-to sequence mapping on the one or more OFDM symbols comprises transmitting a sequence, from a set of candidate sequences, when the MC-OOK outputs an ON value and not transmitting when the MC-OOK outputs an OFF value.

In some implementations, the process includes further comprising selecting the sequence from the set of candidate sequences based on values of bits of the second portion of the LP WUS.

In some implementations, a number of sequences in the set of sequences is based on a number of values for which the MC-OOK outputs an ON value.

In some implementations, one or more sequences in the set of sequences are applied in a time domain for each time segment.

In some implementations, a length of the sequence is based on a number of subcarriers for transmission of the LP WUS in a frequency segment of an OFDM symbol of the one or more OFDM symbols.

In some implementations, the set of one or more UEs comprise an OOK-based receiver, a sequence-based receiver, or a combination thereof.

In some implementations, the MC-OOK is an OOK-1 configuration in which an OFDM symbol corresponds to a single bit, wherein for the OOK-1 configuration the MC-OOK is configured to output a first value for the bit indicating that subcarriers are modulated for a first OFDM symbol corresponding to the first value, and wherein the MC-OOK is further configured to output a second value for the bit indicating that the subcarriers are at zero power, from a baseband perspective, for a second OFDM symbol corresponding to the second value.

In some implementations, the MC-OOK is an OOK-4 configuration in which a time domain signal consists of one or more time segments with each time segment representing a bit, and a number of the subcarriers are generated by a transform of the time domain signal including one of a Fourier transform or a least square transform.

In some implementations, the MC-OOK is an OOK-2 configuration in which an OFDM symbol corresponds to a plurality of bits in parallel using two frequency segments in a frequency domain, wherein for the OOK-2 configuration the MC-OOK is configured to output a respective value for each of the plurality of bits, a first value of a bit of the plurality indicating that the subcarriers of a segment of the OFDM symbol corresponding to the bit are modulated for that segment of the OFDM symbol, and a second value of the bit of the plurality indicating that all subcarriers of the segment of the OFDM symbol corresponding to the bit are at zero power from a baseband perspective.

In some implementations, for each OFDM symbol, a number L=2^{K} of time-domain candidate sequences are available for a time segment of the OFDM symbol or the number L=2^{K} of frequency-domain candidate sequences are available for a frequency segment of the OFDM, wherein K is a number of bits for mapping to one of the number L of the time domain candidate sequences or the frequency domain candidate sequences.

In some implementations, the process includes coding a first set of bits of the first portion to a second set of bits; and modulating the second set of bits using the MC-OOK coding.

In some implementations, the LP WUS carries a group identifier for the set of one or more UEs.

In a general aspect, a process includes receiving, at a device, a low-power wake-up signal (LP WUS) having a first portion of information carried by one or more orthogonal frequency-division multiplexing (OFDM) symbols modulated using multi-carrier on/off keying (MC-OOK) and a second portion of information carried by a bit-to sequence mapping on the one or more OFDM symbols; determining that the LP WUS comprises an identifier that matches an identifier of the device; and based on the determining, initiating a connection of the device with a network element.

In some implementations, the device comprises an OOK-based receiver, and wherein the method comprises determining that the LP WUS comprises the identifier that matches an identifier of the device based on the first portion of information.

In some implementations, the device comprises a sequence-based receiver, and wherein the method comprises determining that the LP WUS comprises the identifier that matches an identifier of the device based on the first portion of information and the second portion of information.

In some implementations, a non-transitory computer storage medium encoded with instructions that, when executed by one or more computers, cause the one or more computers to perform the process described herein.

In a general aspect, a system includes one or more computers and one or more storage devices on which are stored instructions that are operable, when executed by the one or more computers, to cause the one or more computers to perform the process described herein.

In a general aspect, one or more processors are configured to execute instructions stored on memory, the instructions configured to cause the one or more processor to perform the method of any of claims 1 to 25.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates a processing workflow for a first portion of a wake-up signal, according to some implementations.

FIG. 3 illustrates a processing workflow for a first portion of a wake-up signal, according to some implementations.

FIG. 4 illustrates a processing workflow for a first portion of a wake-up signal, according to some implementations.

FIG. 5 illustrates a processing workflow for a second portion of a wake-up signal, according to some implementations.

FIG. 6 illustrates a processing workflow for a second portion of a wake-up signal, according to some implementations.

FIG. 7 illustrates an example of a number of input bits to the WUS encoding workflow and a number of output bits from the WUS encoding workflow based on the input bits.

FIG. 8 illustrates a flowchart of an example method, according to some implementations.

FIG. 9 illustrates an example user equipment (UE), according to some implementations.

FIG. 10 illustrates an example access node, according to some implementations.

### DETAILED DESCRIPTION

A harmonized design for low-power wake-up signals is described herein for Fifth Generation (5G) telecommunications networks. A wake-up signal (WUS) is configured to accommodate user equipment (UE) having one of multiple wake up receiver types. These wake-up receiver typica include an on/off keying (OOK)-based receiver and a sequence-based receiver. The wake-up signal can be a multi-carrier OOK-based waveform by modulating the subcarriers with sequence(s) that are known to the UE. The WUS includes a hybrid design to carry a low-power (LP) WUS payload that can accommodate a mix of the OOK-based receiver and sequence-based receiver at the UEs. The wake-up signal payload is split into two parts. A first part is carried via multi-carrier on/off keying (MC-OOK) modulation. The second part is carried via a bit-to-sequence mapping on the time segment(s) or frequency segment(s) of the MC-OOK orthogonal frequency-division multiplexing (OFDM) symbol(s).

The harmonized design, including the first and second parts of the WUS payload, is configured to satisfy the following objectives in relation to a LP WUS/LP WUR for NR networks. The WUS/WUR configurations described herein can be used by low-power WUS/WUR for power-sensitive, small form-factor devices including internet of things (IoT) devices. The devices that use the LP WUS/WUR described herein can include industrial sensors and controllers, small devices such as wearables, and so forth. L1 procedures and higher layer protocols that support the wake-up signals are described herein.

The harmonized design for the LP WUS/WUR described herein enables power saving mechanism, improved coverage availability, and minimizing a latency impact for UEs. The LP WUS/WUR can also reduce overhead for system impact, such as network power consumption, coexistence with non-low-power-WUR UEs, network coverage/capacity/resource overhead, and so forth.

The harmonized design (also called a unified signal design) and the corresponding procedures described herein can accommodate different types of LP WUR. The WUS described herein can use multi-carrier amplitude shift-keying (MC-ASK) modulation, including on-off keying (OOK) waveforms. On-off keying (OOK) denotes a form of amplitude-shift keying (ASK) modulation that represents digital data as the presence or absence of a carrier wave. Amplitude-shift keying (ASK) is a form of amplitude modulation that represents digital data as variations in the amplitude of a carrier wave.

For MC-ASK waveform generation where X is the length of the input signal for the inverse Fast Fourier transform (IFFT) of CP-OFDM, or the IFFT size, and Z is the number of subcarriers used by LP-WUS including potential guard bands, the following options can be used. In the first option, OOK-1, a single bit in one OFDM symbol, subcarriers of LP-WUS are the following. When OOK is one, all subcarriers (except for e.g., the subcarriers in the guard bands) are modulated. When OOK is 0, all sub carriers are at zero power from the baseband perspective.

In the second option, OOK-2, a parallel M-bit OOK in the frequency domain is used. A number Z of subcarriers of the LP-WUS is further separated into M segments with guard bands potentially either in-between or around each segment, with one bit carried in each segment. In the second option, when OOK is 1, all subcarriers (except for e.g., the subcarriers in the guard bands) in the segment are modulated. In this second option, when OOK is 0, also carries in the segment are at zero power from the baseband perspective.

In the third option, OOK-3, a multi-tone single-bit OOK is used. In this third option, a number Z of subcarriers of the LP-WUS are separated into a number L segments without guard bands in between the segments but possibly around all the segments. In this third option, when OOK is one, one subcarrier, known by the UE, of each segment is modulated. In this third option, when OOK is 0, the known subcarrier to the UE in each segment are at zero power from the perspective of the baseband.

In the fourth option, OOK-4, an M-bit OOK in the time domain is transformed. In the fourth option, Y′ samples are generated from M-bits. Signal modification may or may not be used. A number Y of subcarriers are generated by a transformation such as a size Y′ DFT or least square approximation, with or without a truncation or other additional modification. If a truncation or other modification is not used, Y is the same as Y′. Here, Y′ can be the same as X. Modulated subcarriers can include QAM symbols, sequences, or other signals. Note that Y may be smaller than Z when guard bands are considered.

The WUS described herein can include a waveform generated by modulating sub-carriers of CP-OFDM symbol, consider up to M bits transmitted per OFDM symbol, where M is predefined. In some implementations, the modulation can include discrete Fourier transform-spread-orthogonal frequency division multiplexing (DFT-S-OFDMA). In single carrier frequency division multiple access (SC-FDMA) systems, a modulation is used in which each transmitting device is allocated a single carrier and a finite portion of the channel bandwidth, and every transmitting device is separated from adjacent devices by a finite amount of spacing to prevent interference. DFT-S-OFDMA eliminates the need for spacing between users and combines all the users orthogonally such that the peak of one user coincides with the null of other users. The WUS can further use multi-carrier frequency shift-keying (MC-FSK) waveforms. The network can generate WUS waveforms by modulating sub-carriers of cyclic prefix-orthogonal frequency division multiplexing (CP-OFDM) symbols, where there are up to M bits transmitted per OFDM symbol, where M is predefined. The WUS can further use OFDMA-based signals/channels considering at least a legacy signal/channel structure, such as a channel state information reference signal (CSI-RS), a secondary synchronization signal (SSS), and so forth. Other such signal/channel structures can also be used. For OFDMA-based signals/channels, the WUS can include sequence-based signal for complexity reduction, such as a ZC sequence, an m-sequence, or a gold sequence.

The hybrid design for the LP WUS/WUR is configured to carry a LP WUS payload that can accommodate a mix of the OOK-based receivers and sequence-based receivers at the UEs. The hybrid LP WUS/WUR configuration enables flexibility for choosing a receiver type for the UE. The UE can have a receiver type to achieve different tradeoffs on complexity, power consumption, and performance. The network generates a multi-carrier OOK-based waveform by modulating the subcarriers with sequence(s) that are known to the UE.

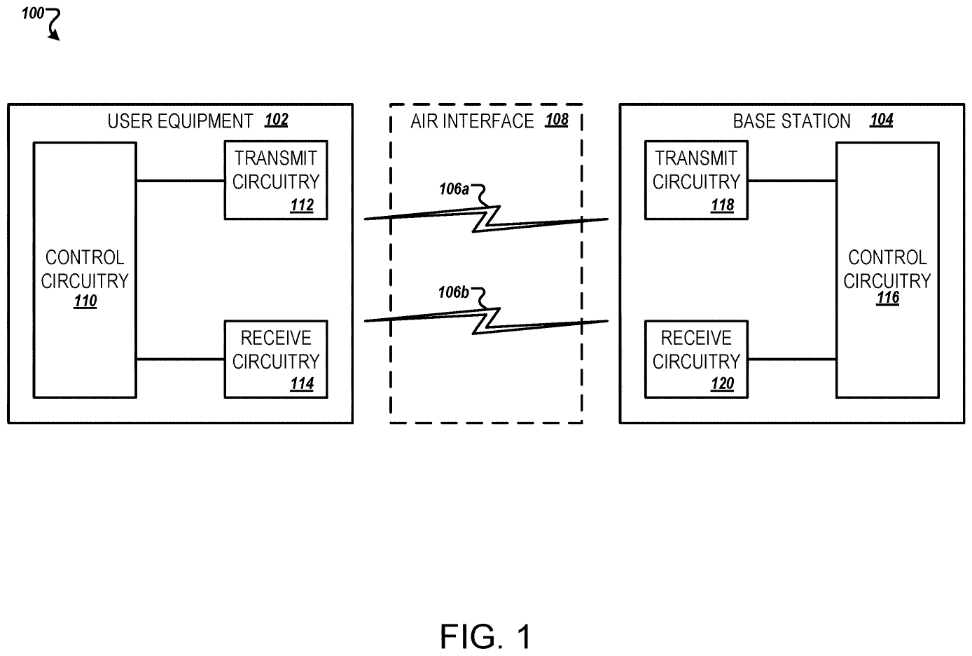

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE.

The transmit circuitry 112 can perform various operations described in this specification. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

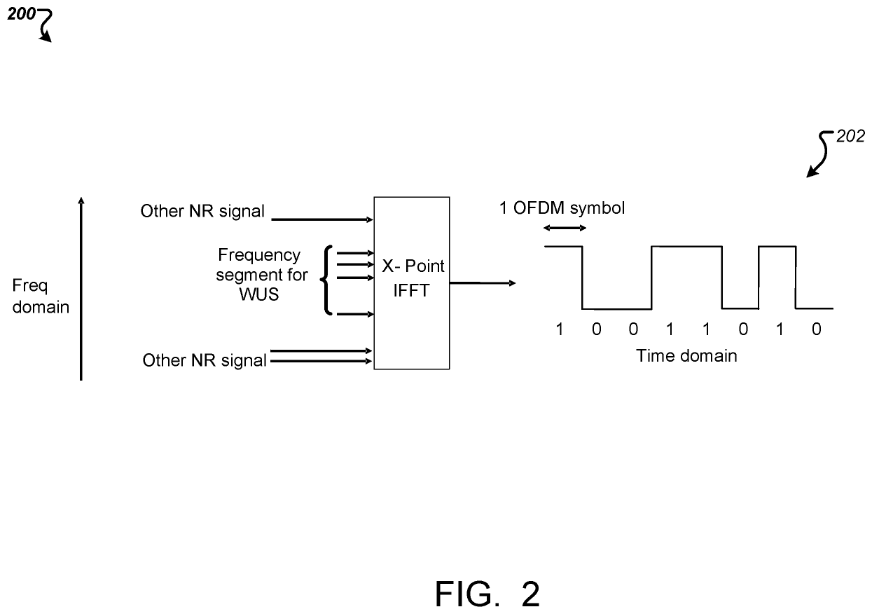

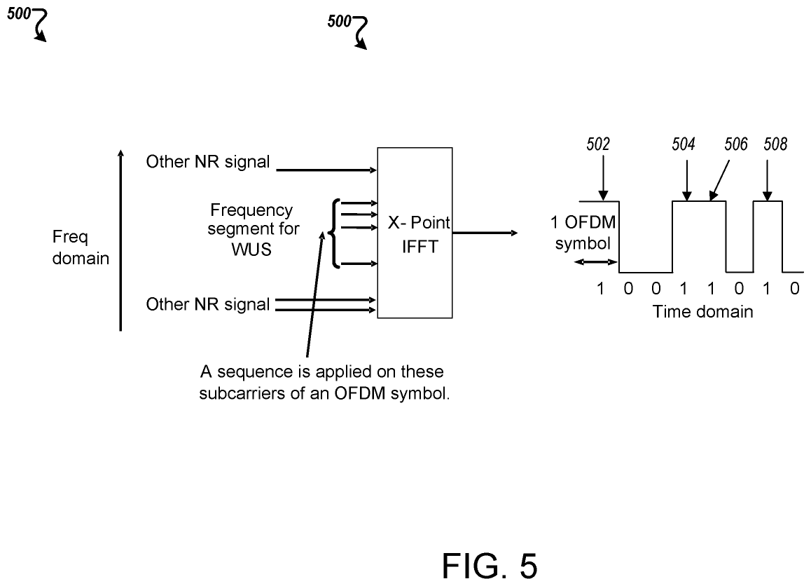

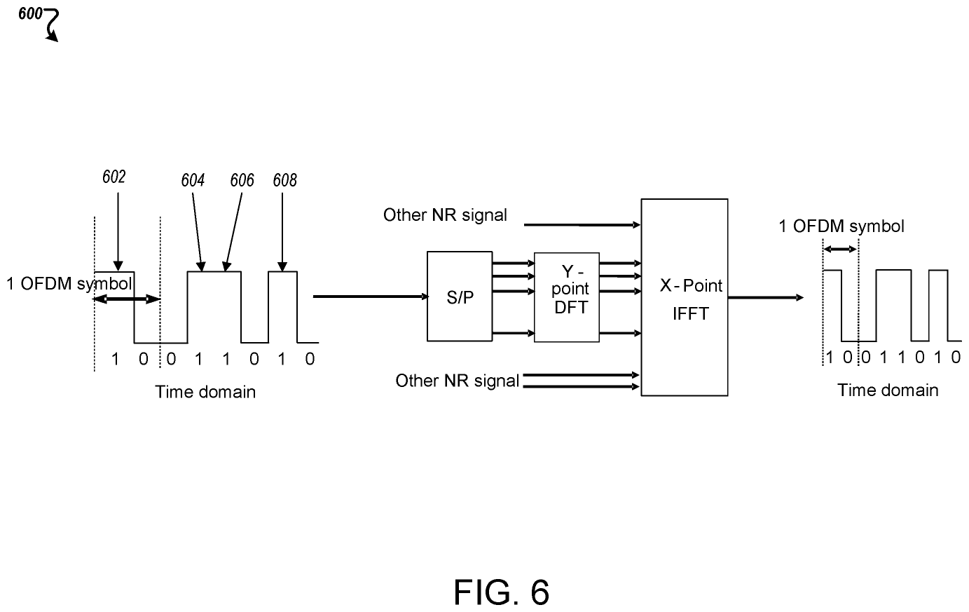

Each of FIGS. 2-4 illustrates a processing workflow for a first portion of a wake-up signal, according to some implementations. FIGS. 5-6 each illustrates a processing workflow for a second portion of a wake-up signal (WUS), according to some implementations. The first and second portions of the WUS are described in further detail below.

The low power WUS (LP WUS) payload for a UE (or a group of UEs) is split into two portions. A first portion of the WUS is carried based on MC-OOK modulation. The second portion of the LP WUS is carried based on bit-to-sequence mapping on the time or frequency segment(s) of the MC-OOK OFDM symbol(s). The hybrid nature of the carrier modulation enables flexibility for the UEs that receive and use the LP WUS to perform communication operations, as previously described.

Each of the first and second portions of the hybrid LP WUS described herein can carry various payloads. The exact content of LP WUS payload may typically include a UE identifier or a group identifier. These identifiers represent the targeted UE(s). In some implementations, the LP WUS includes a bitmap. In this example, each bit corresponds to a UE or UE group. The LP WUS may additionally include bits representing one or more of a cell identifier (CID), a system information modification notification, earthquake and tsunami warning system or commercial mobile alert system (ETWS/CMAS) information, tracking area information, and radio access network (RAN) area information. Generally, the LP WUS payload can be represented by a number of bits. The two portions of the hybrid LP WUS distinguish how the payload is carried in the LP WUS.

The two portions of the hybrid LP WUS enable different types of receivers to receive the LP WUS. Specifically, the two portions of the hybrid LP WUS enable an OOK-based receiver and a sequence-based receiver to receive the LP WUS. The OOK-based receiver is configured to detect the first portion of the LP WUS payload. The sequence-based receiver is configured to detect the entire LP WUS payload. The first portion of LP WUS payload should include at least the essential information that to enable the UE to operate responsive to the LP WUS. The additional information in the second portion provides further benefits such as improved lower wake-up probability and/or better performance. In another example, the two portions of the hybrid LP WUS enable responsiveness by UEs if only UEs with one type of receiver, either OOK-based receiver or sequence-based receiver, are present in the network.

The first portion of the hybrid LP WUS is now generally described, and specific implementations are subsequently described in further detail in relation to FIGS. 2-4. In an example, the first portion of the LP WUS payload includes M1 bits (e.g., an M number of bits). The M1 bits may be encoded into N1 bits (e.g., an N number of bits). The coding for the first portion can include most any type of forward error correcting/detection code, Manchester coding, and so forth. In some implementations, if the coding is not applied, then N1=M1. The N1 bits are modulated into one or more OFDM symbols via MC-OOK. For bit ‘0’, there is no transmission of the LP WUS. For bit ‘1’, the LP WUS signal is transmitted on a time and/or frequency segment (e.g., multiple subcarriers) of an OFDM symbol. The configuration for transmissions on MC-OOK bits at value ‘1’ enables an OOK-based receiver (e.g., a UE) to receive the first part of the WUS identifier.

The second portion of the hybrid LP WUS is now generally described, and specific implementations are subsequently described in further detail in relation to FIGS. 5-6. The second portion of the hybrid LP WUS includes M2 bits. In some implementations, the M2 bits may be encoded into N2 bits. The coding for the second portion can include most any type of forward error correcting/detection code, Manchester coding, and so forth. In some implementations, if the coding is not applied, then N2=M2. For the second portion of the hybrid LP WUS, the number of L of time-domain or frequency-domain candidate sequences that are available is L=2^{K}. The time-domain or frequency-domain candidate sequences are available to be used on a time or frequency segment of an OFDM symbol. K bits can be mapped to one of the L candidate sequences. The N2 bits are divided into multiple of K bits, and each of the K bits is used (e.g., by the UE) to select the candidate sequence for a time or frequency segment of an OFDM symbol that carries a transmitted signal (e.g., a time or frequency segment that carry OOK bit ‘1’). Because no signal is transmitted for OOK bit ‘0’, this portion of the signal cannot carry any additional information. Based on the configurations of each of the first and second portions of the hybrid LP WUS, a UE that includes a sequence-based receiver can receive both the first and second portions of the LP WUS payload.

In some implementations, there is only a single candidate sequence for a time or frequency segment of an OFDM symbol, and no additional information is carried in the second portion of the LP WUS payload identifier. In this example, both OOK-based receiver and sequence-based receiver receive the same LP WUS payload. The sequence-based receiver may have better receive performance compared to OOK-based receiver, and the sequence-based receiver may have a higher power consumption. Each of the two portions of the LP WUS are subsequently described in further detail in relation to FIGS. 2-6.

FIG. 2 illustrates a processing workflow 200 for a first portion of a wake-up signal, according to some implementations. The processing workflow 200 shows how the first portion of the LP WUS payload can be carried using OOK-modulated OFDM symbols. In workflow 200, the first portion of the LP WUS payload includes a UE group identifier that includes 4 bits (e.g., 1011). In this example, a Manchester coding is applied, and the encoded bit sequence 202 is 10011010. The encoded bits are modulated using MC-OOK. Different variations of MC-OOK can be used, including one of OOK-1, OOK-2, OOK-3, or OOK-4, each of which is previously described. In this case, one OFDM symbol carries one bit using one frequency segment. The modulation scheme of workflow 200 corresponds to OOK-1, previously described.

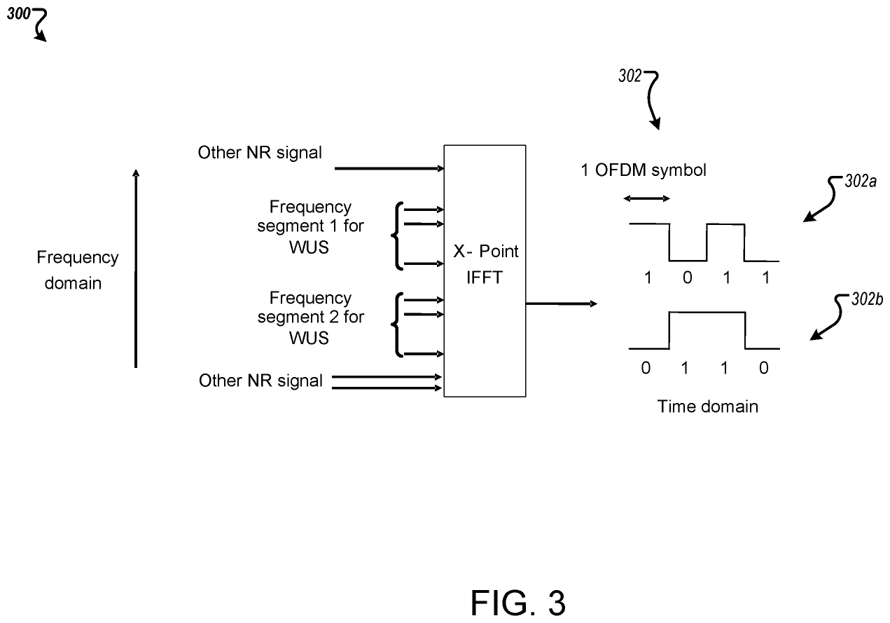

FIG. 3 illustrates a processing workflow 300 for a first portion of a wake-up signal, according to some implementations. The processing workflow 300 shows how the first portion of the LP WUS payload can be carried using OOK-modulated OFDM symbols. In workflow 300, the first portion of the LP WUS payload includes a UE group identifier that includes 4 bits (e.g., 1011). In this example, the sequence 302 represents the case in which one OFDM symbol carries two bits using two frequency segments 302a, 302b in parallel. The first frequency segment carries two bits (e.g., 11, which are encoded into 4 bits 1010 using Manchester coding). The second frequency segment carries two bits (e.g., 01, which are encoded into 4 bits 0110 using Manchester coding). The modulation scheme of workflow 300 corresponds to OOK-2, previously described.

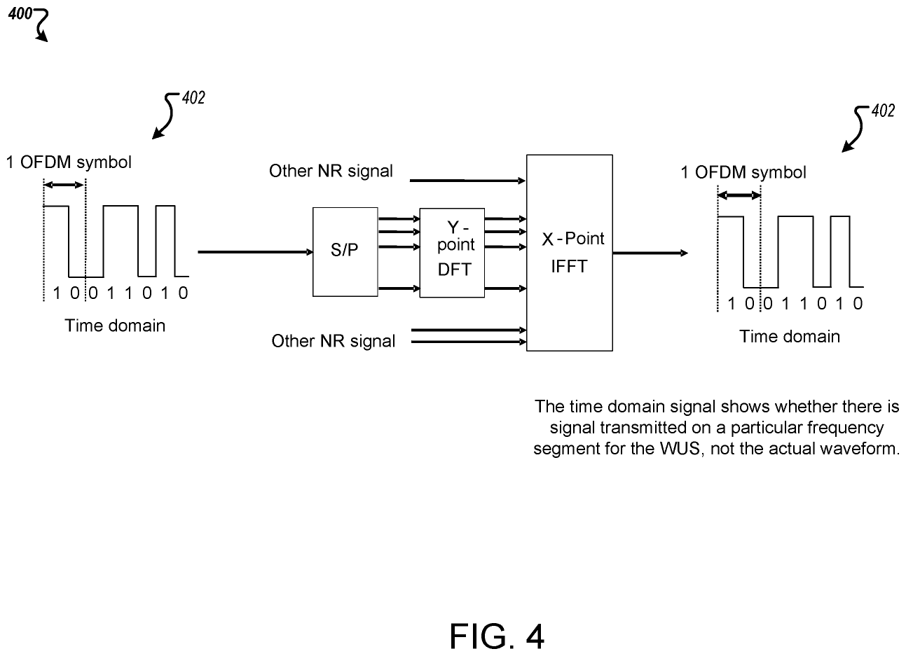

FIG. 4 illustrates a processing workflow for a first portion of a wake-up signal, according to some implementations. The processing workflow 400 shows how the first portion of the LP WUS payload can be carried using OOK-modulated OFDM symbols. In workflow 400, the first portion of the LP WUS payload includes a UE group identifier that includes 4 bits (e.g., 1011). In this example, a Manchester coding is applied, and the encoded bit sequence 402 is 10011010. In this case, one OFDM symbol carries two bits using two time-domain segments, where each bit occupies half of the OFDM symbol. The modulation scheme of workflow 400 corresponds to OOK-4, previously described.

FIG. 5 and FIG. 6 illustrates processing workflows 500 and 600, respectively, for a second portion of a wake-up signal, according to some implementations. The second portion of the LP WUS in some implementations, carried by bit-to-sequence mapping on an OFDM symbol in either the time domain or the frequency domain. There are multiple candidate sequences for each time segment when the processing workflow 400 is applied for the first portion of the LP WUS corresponding to OOK-4. There are multiple candidate sequences for each frequency segment when either of the processing workflows 200 or 300, respectively corresponding to OOK-1 and OOK-2, is used for the payload of the OFDM symbol for the first portion of the LP WUS. The multiple candidate sequences may be the same or different across different time or frequency segments of different OFDM symbols.

Example sequences are now described. A sequence, s_{n,k,i} represents the i-th sequence (i=0, 1, 2, 3) in the k-th time or frequency segment of the n-th OFDM symbol. If the sequence is applied to a frequency segment in frequency domain, the sequence length is the same as the number of subcarriers used for WUS transmission in a frequency segment. The sequence is mapped to the multiple subcarriers on an OFDM symbol, with each entry in the sequence mapped to one subcarrier. If the sequence is applied to a time segment in time domain, the sequence length is the same as the number of samples in the time domain in a time segment. In a first example, the second portion of the LP WUS payload includes 2 bits. The 2 bits in the second portion of the LP WUS payload are used to select one sequence of the four candidate sequences in each time or frequency segment of an OFDM symbol. In this example, if the 2 bits are ‘00’ (or ‘01’, ‘10’, ‘11’), s_{n,k,0} (or s_{n,k,1}, s_{n,k,2}, s_{n,k,3}) is selected for transmission in all time or frequency segments of all the OFDM symbols that have OOK bit ‘1’. The functionality of this process is similar to applying repetition code to the 2 bits. Each of the 2 bits are carried on a time or frequency segment of a OFDM symbol. In a second example, the second portion of the LP WUS payload has 8 bits (b₀, b₁, b₂, b₃, b₄, b₅, b₆, b₇).

As shown in the workflow 500 of FIG. 5, the second portion of the LP WUS payload is carried assuming that OOK-1 is applied, as shown in FIG. 2, for the first portion of the LP WUS payload. Of the 8-bit sequence, (b₀, b₁) are used to select the sequence for the 1st OFDM symbol that carries OOK bit ‘1’, which is the first OFDM symbol 502. Of the 8-bit sequence, (b₂, b₃) are used to select the sequence for the second OFDM symbol that carries OOK bit ‘1’, which is the fourth OFDM symbol 504. Of the 8-bit sequence, (b₄, b₅) are used to select the sequence for the third OFDM symbol that carries OOK bit ‘1’, which is the fifth OFDM symbol 506. Of the 8-bit sequence, (b₆, b₇) are used to select the sequence for the fourth OFDM symbol that carries OOK bit ‘1’, which is the seventh OFDM symbol 508. While this example is illustrative for the workflow of FIG. 2 in which OOK-1 is used, this process of FIG. 5 can be extended for scenarios in which workflow 300 of FIG. 3 is used, and the first portion of the LP WUS is modulated using OOK-2.

FIG. 6 illustrates a processing workflow 600 for a second portion of a wake-up signal, according to some implementations. The second portion of the LP WUS payload is carried in workflow 600 when OOK-4 is used for the first portion of the LP WUS payload, such as shown in the workflow 400 of FIG. 4. A time-domain sequence is applied on the time samples of each time segment (e.g., segments 602, 604, 606, 608) that carries bit ‘1.’ Specifically, the second portion of the LP WUS payload has 8 bits (b₀, b₁, b₂, b₃, b₄, b₅, b₆, b₇). As shown in workflow 600, of the 8-bit sequence, 2 bits (b₀, b₁) are used to select the sequence for the first time segment 602 that carries OOK bit ‘1’, which is the first time segment of the first OFDM symbol. Of the 8-bit sequence, 2 bits (b₂, b₃) are used to select the sequence for the second time segment 604 that carries OOK bit ‘1’, which is the second time segment of the second OFDM symbol. Of the 8-bit sequence, 2 bits (b₄, b₅) are used to select the sequence for the third time segment 606 that carries OOK bit ‘1’, which is the first time segment of the third OFDM symbol. Of the 8-bit sequence, 2 bits (b₆, b₇) are used to select the sequence for the fourth time segment 608 that carries OOK bit ‘1’, which is the first time segment of the fourth OFDM symbol.

Another example sequence can be used for the second portion of the LP WUS payload. In this example, the second portion of the LP WUS payload includes 4 bits (b₀, b₁, b₂, b₃). The 4 bits (b₀, b₁, b₂, b₃) are encoded using code rate of 1/2, and the coded bits are (c₀, c₁, c₂, c₃, c₄, c₅, c₆, c₇). Each of bit pairs (c₀, c₁), (c₂, c₃), (c₄, c₅) and (c₆, c₇) are used to select the sequences for the time or frequency segments that carry OOK bit ‘1.’ This is similar as the workflow 600 as described in relation to FIG. 6.

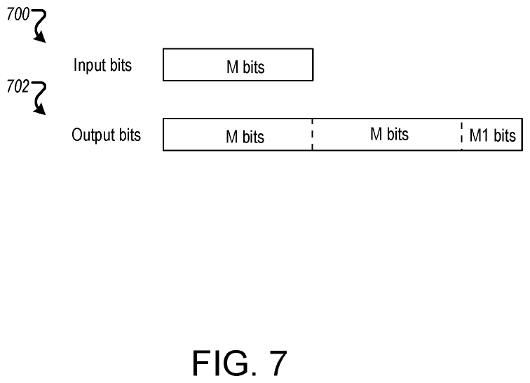

In the second portion of the LP WUS payload, as previously described, the information is carried on the time segment or the frequency segment when the OOK bit ‘1’ is transmitted, but not when a ‘0’ is transmitted. The number of OOK bits that are a value of ‘1’ may be variable, depending on the payload and depending on the coding scheme. The output can include a variable number of output bits for the second portion of the LP WUS payload, as shown in input 700 and output 702 of FIG. 7. The length of the output 702 depends on the number of OOK bits that are a value of ‘1.’ In some implementations, when Manchester coding is applied, the number of ‘1’ values in the OOK output is fixed. This number is the same as the number of bits before coding. When a more generic coding scheme is applied, the output can be variable. For variable output bits, a rate matching scheme can be used to encode the second portion of the LP WUS payload. For example, by using a repetition code, as described previously, a same sequence index is used in each segment. In some implementations, when the number of output bits is larger than the input bits or the coded bits, the bits can be carried in a cyclic way. As shown in the output 702, assuming the number of input bits in the second portion of the LP WUS payload is M, the M bits are repeated in a cyclic way until all the output bits are populated. In this example, there are two complete repetitions of the M bits plus the first M1 bits of the M bits.

A system perspective of the application of the first and second portions of the LP WUS payload is now described using two examples. In the system, there are multiple UEs monitoring the same LP WUS monitoring occasion. A portion of the UEs have an OOK-based receiver. A portion of the UEs have a sequence-based receiver.

A first system example is now described. The LP WUS payload includes is a group identifier which has a total of 6 bits (a₀, a₁, a₂, a₃, a₄, a₅). In this example, The LP WUS payload is split into two portions. The first portion includes (a₀, a₁, a₂, a₃). The second portion includes (a₄, a₅). The first portion therefore includes a 4-bit payload. The first portion is encoded into 8 bits based on Manchester coding, which can be modulated into OFDM symbols by MC-OOK, as previously described. The 2-bit payload of the second portion of the payload is used to determine which sequences are used by the UE for the time or frequency segments of the OFDM symbols, as previously described in relation to FIGS. 5-6. A given UE with OOK-based receiver can only detect the 4-bit payload of the first portion. In this case, the UE already knows its own 4-bit group identifier (e.g., based on its own UE ID or configured by the network). The UE is configured to determine whether the first portion of the payload matches the known 4-bit group identifier. If the UE determines that there is a match, the UE determines that the LP WUS is applicable (targeted) to itself. In another case, a given UE has a sequence-based receiver. In this case, the UE already has its own 6-bit group identifier. The UE can detect whether the full LP WUS payload matches its own group identifier with known sequence information. If the UE determines that a match has been found, the UE can determine that the LP WUS is applicable (targeted) to itself.

A second system example is now described. The LP WUS is configured to carry a group identifier for the UEs. The group identifier includes a total of 4 bits (a₀, a₁, a₂, a₃). The group identifier is split into two parts, including a first part that includes (a₀, a₁) and a second part that includes (a₂, a₃). The first part of the group identifier includes 2 bits, which translates into 4 groups of UEs. In this example, a 4-bit bitmap is carried in the WUS. Each bit in the bitmap indicates a corresponding group of UEs, and specifically signaling whether those UEs should wake up or not. The 4 bits corresponding to (a₀, a₁) are included in the first portion of the LP WUS payload. The 4-bit payload of the first portion of the LP WUS payload is encoded into 8-bits, such as by Manchester coding. The coding can be modulated into OFDM symbols by MC-OOK modulation, as described previously.

In this example, a base station (e.g., a next generation node (gNB)), determines to wake up three UEs including UE1, UE2, and UE3. The base station wakes up the group of UEs based on respective group identifiers ‘0001’, ‘1010’, and ‘1100.’ In this example, based on the first 2 bits of the group identifiers, UE1, UE2, and UE3 belong to a first group, a third group, and a fourth group, respectively. The first portion of the LP WUS payload is ‘1011’. The encoded bits are ‘10011010’. The two bits, (a₂, a₃) of UEL are used to determine the sequence carried in the first OOK bit having a value ‘1’. The two bits, (a₂, a₃) of UE2 are used to determine the sequence carried in the third OOK bit having a value ‘1’. The two bits, (a₂, a₃) of UE3 are used to determine the sequence carried in the fourth OOK bit having a value ‘1’.

The base station also determines a sequence for OOK bits of value ‘1’ that are not associated with a group identifier. In this example, the 2nd OOK bit has a value ‘1,’ but no identifier or defined sequence. In this case, one or more of the following sequences are used. In some implementations, a predefined sequence is used. In some implementations, a sequence selection is left to the base station implementation. However, none of the UEs in the second group should wake up according to the WUS. In this case, the sequence that is used indicates that no UEs are to wake up, regardless of the particular implementation used.

In some implementations, for a UE with OOK-based receiver, the UE is configured to detect a 4-bit payload ‘1011’ (group identifier) for the first portion of the LP WUS payload. The UE is configured to wake up when that UE belongs to the first group, third group, or the fourth group.

In some implementations, for a UE with sequence-based receiver, the UE is configured to detect a 4-bit payload ‘1011’ for the first portion of the LP WUS payload. The UE with sequence-based receiver also detects the (a₂, a₃) for that UE's corresponding group. When the detected information matches the group ID of that UE, the UE determines that the LP WUS is targeted for itself and is configured to wake.

In some implementations, the base station attempts to wake up more than one UE in one group. If the two bits, (a₂, a₃), used to determine the sequence carried by the OOK bit ‘1’, of all the UEs are not the same, the second portion of the LP WUS may not be able to carry the two bits (a₂, a₃) for all of the UEs. In this case, a sequence is used that is defined to indicate that all the UEs in this group should wake up, regardless of the value of (a₂, a₃) for any particular UE in the group.

A third system example is now described. In this example, the first portion of the LP WUS payload part 1 includes a 4-bit bitmap. Each bit (a₀, a₁, a₂, a₃) of the bitmap indicates whether a corresponding group of UEs should wake up or not. This is similar to the previously described example. In this example, the first part of the 4-bit payload is encoded into 8 bits by Manchester coding, which can be modulated into OFDM symbols based on MC-OOK, as previously described.

The second portion of the LS WUS payload includes 2 bits (b₀, b₁). The two bits (b₀, b₁) include a system information modification indication and an ETWS/CMAS indication. The 2 bits (b₀, b₁) are used to select the sequences used for the time or frequency segments of the OFDM symbols. For a UE with either an OOK-based receiver or sequence-based receiver, the UE can detect the first portion including the 4-bit payload. Based on the UE's own group identifier, the UE determines whether the LP WUS is targeted for itself. If the UE has a sequence-based receiver, the UE can additionally detect the system information modification indication and the ETWS/CMAS indication of the second portion of the LP WUS. Based on the indications of the second portion of the LP WUS, the UE determines whether the UE should wake up to receive updated system information and/or ETWS/CMAS messages.

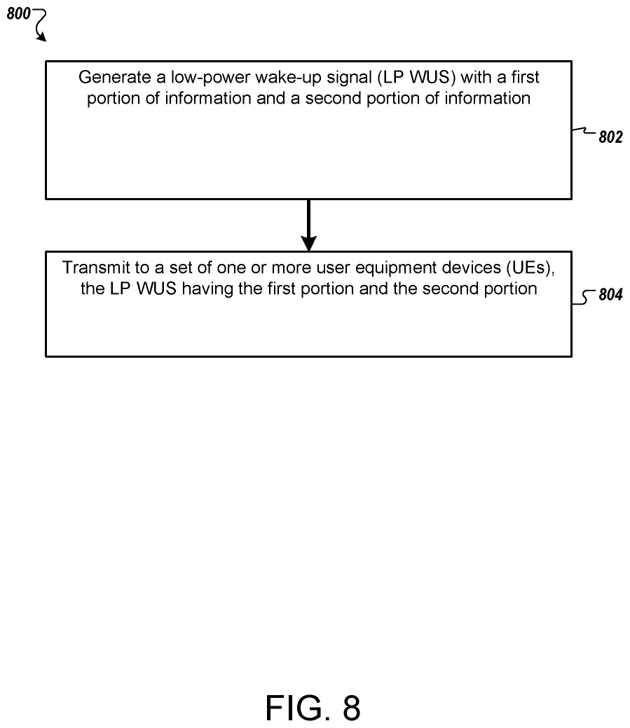

FIG. 8 illustrates a flowchart of an example method 800, according to some implementations. For clarity of presentation, the description that follows generally describes method 800 in the context of the other figures in this description. For example, method 800 can be performed by UE 102 of FIG. 1. It will be understood that method 800 can be performed, for example, by any suitable system, environment, software, hardware, or a combination of systems, environments, software, and hardware, as appropriate. In some implementations, various steps of method 800 can be run in parallel, in combination, in loops, or in any order. The process 800 can include generating (802) a low-power wake-up signal (LP WUS) having a first portion of information carried by one or more orthogonal frequency-division multiplexing (OFDM) symbols are modulated based on multi-carrier on/off keying (MC-OOK). The LP WUS includes a second portion of information carried by a bit-to sequence mapping on the one or more OFDM symbols. The process 800 includes transmitting (804), to a set of one or more user equipment devices (UEs), the LP WUS having the first portion and the second portion.

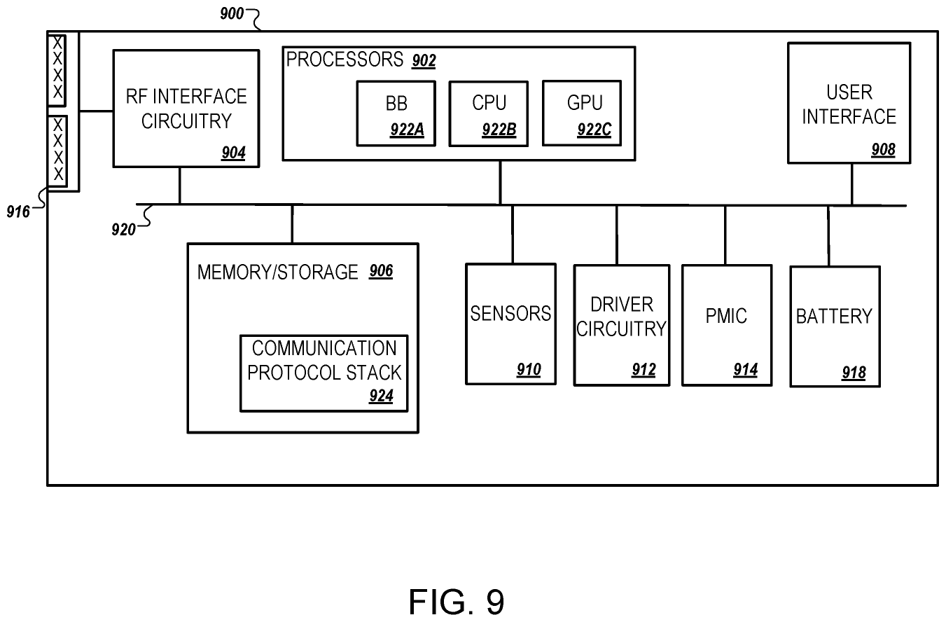

FIG. 9 illustrates an example UE 900, according to some implementations. The UE 900 may be similar to and substantially interchangeable with UE 102 of FIG. 1. The UE 900 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 900 may include processors 902, RF interface circuitry 904, memory/storage 906, user interface 908, sensors 910, driver circuitry 912, power management integrated circuit (PMIC) 914, one or more antenna(s) 916, and battery 918. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 920, which may represent any type of interface, input/output, bus (local, system, or expansion), transmission line, trace, optical connection, etc. that allows various circuit components (on common or different chips or chipsets) to interact with one another.

The processors 902 may include processor circuitry such as, for example, baseband processor circuitry (BB) 922A, central processor unit circuitry (CPU) 922B, and graphics processor unit circuitry (GPU) 922C. The processors 902 may include any type of circuitry or processor circuitry that executes or otherwise operates computer-executable instructions, such as program code, software modules, or functional processes from memory/storage 906 to cause the UE 900 to perform operations as described herein.

In some implementations, the baseband processor circuitry 922A may access a communication protocol stack 924 in the memory/storage 906 to communicate over a 3GPP compatible network. In general, the baseband processor circuitry 922A may access the communication protocol stack to perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 904. The baseband processor circuitry 922A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 906 may include one or more non-transitory, computer-readable media that includes instructions (for example, communication protocol stack 924) that may be executed by one or more of the processors 902 to cause the UE 900 to perform various operations described herein. The memory/storage 906 include any type of volatile or non-volatile memory that may be distributed throughout the UE 900. In some implementations, some of the memory/storage 906 may be located on the processors 902 themselves (for example, L1 and L2 cache), while other memory/storage 906 is external to the processors 902 but accessible thereto via a memory interface. The memory/storage 906 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 904 may include transceiver circuitry and radio frequency front module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 916 and proceed to filter and amplify (with a low-noise amplifier) the signal. The signal may be provided to a receiver of the transceiver that downconverts the RF signal into a baseband signal that is provided to the baseband processor of the processors 902.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 916. In various implementations, the RF interface circuitry 904 may be configured to transmit/receive signals in a manner compatible with NR access technologies.

The antenna(s) 916 may include one or more antenna elements to convert electrical signals into radio waves to travel through the air and to convert received radio waves into electrical signals. The antenna elements may be arranged into one or more antenna panels. The antenna(s) 916 may have antenna panels that are omnidirectional, directional, or a combination thereof to enable beamforming and multiple input, multiple output communications. The antenna(s) 916 may include microstrip antennas, printed antennas fabricated on the surface of one or more printed circuit boards, patch antennas, phased array antennas, etc. The antenna(s) 916 may have one or more panels designed for specific frequency bands including bands in FR1 or FR2.

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 910 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various input/output (I/O) devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensors 910 and control and allow access to sensors 910, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processors 902, the PMIC 914 may control power-source selection, voltage scaling, battery charging, or DC-to-DC conversion.

In some implementations, the PMIC 914 may control, or otherwise be part of, various power saving mechanisms of the UE 900. A battery 918 may power the UE 900, although in some examples the UE 900 may be mounted deployed in a fixed location and may have a power supply coupled to an electrical grid. The battery 918 may be a lithium ion battery, a metal-air battery, such as a zinc-air battery, an aluminum-air battery, a lithium-air battery, and the like. In some implementations, such as in vehicle-based applications, the battery 918 may be a typical lead-acid automotive battery.

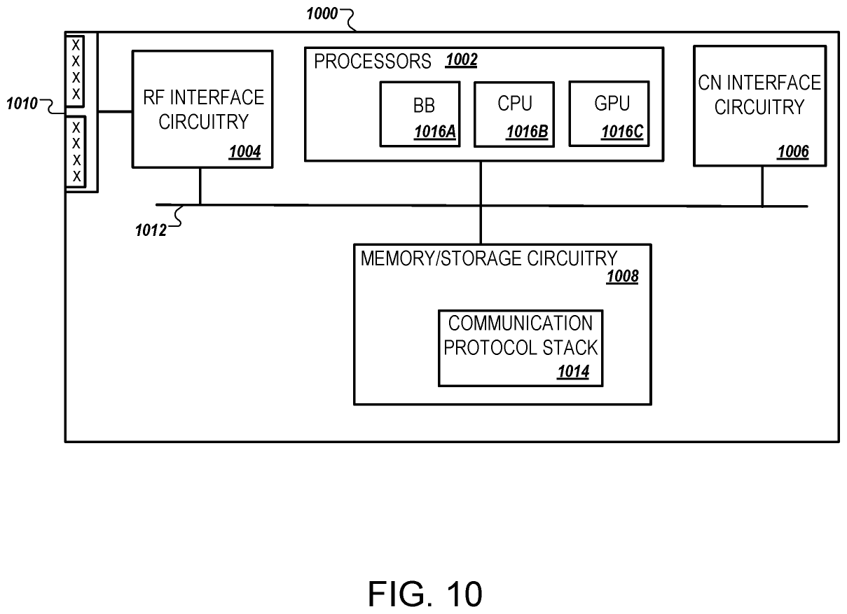

FIG. 10 illustrates an example access node 1000 (e.g., a base station or gNB), according to some implementations. The access node 1000 may be similar to and substantially interchangeable with base station 104. The access node 1000 may include processors 1002, RF interface circuitry 1004, core network (CN) interface circuitry 1006, memory/storage circuitry 1008, and one or more antenna(s) 1010.

The components of the access node 1000 may be coupled with various other components over one or more interconnects 1012. The processors 1002, RF interface circuitry 1004, memory/storage circuitry 1008 (including communication protocol stack 1014), antenna(s) 1010, and interconnects 1012 may be similar to like-named elements shown and described with respect to FIG. 9. For example, the processors 1002 may include processor circuitry such as, for example, baseband processor circuitry (BB) 1016A, central processor unit circuitry (CPU) 1016B, and graphics processor unit circuitry (GPU) 1016C.

The CN interface circuitry 1006 may provide connectivity to a core network, for example, a 5th Generation Core network (5GC) using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or FPGAs to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various implementations, the access node 1000 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1000 may be implemented as one or more software entities running on server computers as part of a virtual network, which may be referred to as a CRAN and/or a virtual baseband unit pool (vBBUP). In V2X scenarios, the access node 1000 may be or function as a “Roadside Unit.” The term “Roadside Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An apparatus for communicating over a wireless network, the apparatus comprising processing circuitry configured to perform operations comprising:
generating a low-power wake-up signal (LP WUS) having a first set of bits carried by one or more orthogonal frequency-division multiplexing (OFDM) symbols via modulation based on multi-carrier on/off keying (MC-OOK) and a second set of bits carried by a bit-to sequence mapping on the one or more OFDM symbols; and
preparing for transmission the generated LP WUS.

2. The apparatus of claim 1, wherein the bit-to sequence mapping on the one or more OFDM symbols causes transmission of a sequence, from a set of candidate sequences, when the MC-OOK outputs an ON value and prevents transmission of the sequence when the MC-OOK outputs an OFF value.

3. The apparatus of claim 2, the operations further comprising selecting the sequence from the set of candidate sequences based on values of bits of the second set of bits of the LP WUS.

4. The apparatus of claim 2, wherein a number of sequences in the set of sequences is based on a number of values for which the MC-OOK outputs an ON value.

5. The apparatus of claim 2, wherein one or more sequences in the set of sequences are applied in a time domain for each time segment.

6. The apparatus of claim 2, wherein a length of the sequence is based on a number of subcarriers for transmission of the LP WUS in a frequency segment of an OFDM symbol of the one or more OFDM symbols.

7. (canceled)

8. The apparatus of claim 1, wherein the MC-OOK includes an OOK-1 configuration in which an OFDM symbol corresponds to a single bit, wherein for the OOK-1 configuration the MC-OOK is configured to output a first value for the single bit indicating that subcarriers are modulated for a first OFDM symbol corresponding to the first value, and wherein the MC-OOK is further configured to output a second value for the single bit indicating that the subcarriers are at zero power, from a baseband perspective, for a second OFDM symbol corresponding to the second value.

9. The apparatus of claim 1, wherein the MC-OOK includes an OOK-4 configuration in which a time domain signal consists of one or more time segments with each time segment representing a bit, and a number of subcarriers are generated by a transform of the time domain signal including one of a Fourier transform or a least square transform.

10. The apparatus of claim 1, wherein the MC-OOK includes an OOK-2 configuration in which an OFDM symbol corresponds to a plurality of bits in parallel using two frequency segments in a frequency domain, wherein for the OOK-2 configuration the MC-OOK is configured to output a respective value for each of the plurality of bits, a first value of a bit of the plurality indicating that subcarriers of a segment of the OFDM symbol corresponding to the bit are modulated for that segment of the OFDM symbol, and a second value of the bit of the plurality indicating that all subcarriers of the segment of the OFDM symbol corresponding to the bit are at zero power from a baseband perspective.

11. The apparatus of claim 1, wherein, for each OFDM symbol, a number L=2^{K} of time-domain candidate sequences are available for a time segment of the OFDM symbol or the number L=2^{K} of frequency-domain candidate sequences are available for a frequency segment of the OFDM, wherein K is a number of bits for mapping to one of the number L of the time-domain candidate sequences or the frequency-domain candidate sequences.

12. (canceled)

13. An apparatus for communicating over a wireless network, the apparatus comprising processing circuitry configured to perform operations comprising:
decoding a low-power wake-up signal (LP WUS) having a first portion of information carried by one or more orthogonal frequency-division multiplexing (OFDM) symbols modulated using multi-carrier on/off keying (MC-OOK) and a second portion of information carried by a bit-to sequence mapping on the one or more OFDM symbols;
determining that the LP WUS comprises an identifier that matches an identifier associated with the apparatus; and
based on the determining, initiating a connection of the apparatus with a network element.

14. The apparatus of claim 13, the operations further comprising determining that the LP WUS comprises the identifier that matches the identifier of the apparatus based on the first portion of information.

15. The apparatus of claim 13, the operations further comprising determining that the LP WUS comprises the identifier that matches the identifier of the apparatus based on the first portion of information and the second portion of information.

16. The apparatus of claim 13, wherein the bit-to sequence mapping on the one or more OFDM symbols is based on a sequence, from a set of candidate sequences, decoded corresponding to when the MC-OOK outputs an ON value and not decoded corresponding to when the MC-OOK outputs an OFF value.

17. The apparatus of claim 16, wherein the sequence is selected from the set of candidate sequences based on values of bits of the second portion of the LP WUS.

18. The apparatus of claim 16, wherein a number of sequences in the set of sequences is based on a number of values for which the MC-OOK outputs an ON value.

19. The apparatus of claim 16, wherein one or more sequences in the set of sequences are configured to be applied in a time domain for each time segment.

20. The apparatus of claim 16, wherein a length of the sequence is based on a number of subcarriers for transmission of the LP WUS in a frequency segment of an OFDM symbol of the one or more OFDM symbols.

21. The apparatus of claim 16, wherein the MC-OOK is an OOK-1 configuration in which an OFDM symbol corresponds to a single bit, wherein for the OOK-1 configuration the MC-OOK is configured to output a first value for the bit indicating that subcarriers are modulated for a first OFDM symbol corresponding to the first value, and wherein the MC-OOK is further configured to output a second value for the bit indicating that the subcarriers are at zero power, from a baseband perspective, for a second OFDM symbol corresponding to the second value.

22. The apparatus of claim 16, wherein the MC-OOK is an OOK-4 configuration in which a time domain signal consists of one or more time segments with each time segment representing a bit, and a number of the subcarriers are generated by a transform of the time domain signal including one of a Fourier transform or a least square transform.

23-27. (canceled)
